(19) United States
(12) Patent Application Publication
(10) Pub. No.: US 2025/0334342 A1
(43) Pub. Date: Oct. 30, 2025

(54) Heat Exchanger With a Reservoir, in Particular for a Thermal Management Module

(71) Applicant: MAHLE International GmbH, Stuttgart (DE)

(72) Inventor: Hicham Rouhana, Korntal-Münchingen (DE)

(21) Appl. No.: 19/189,717

(22) Filed: Apr. 25, 2025

(30) Foreign Application Priority Data
Apr. 29, 2024 (DE) 102024111894.6

(51) Int. Cl. F28D 9/00; B60H 1/00; F25B 39/04

(52) U.S. Cl. CPC F28D 9/0093; B60H 1/00342; F25B 39/04; F28D 9/0075; F25B 2339/043

(57) ABSTRACT

A heat exchanger, in particular for a thermal management module is provided and includes, numerous plates, a first flow path for a coolant, a second flow path for a refrigerant, and a reservoir for separating gaseous and liquid portions of the refrigerant from one another and/or for collecting and storing the refrigerant, wherein the plates are stacked or placed next to one another such that channels are formed between adjacent plates. A first part of the channels belongs to the first flow path, and a second part of the channels belongs to the second flow path. The second flow path contains a first section for heating and condensing the vaporous refrigerant, and the second flow path contains a second section for super-cooling the condensed refrigerant. The refrigerant flows from the first section into the second section via the reservoir. The plates each have at least five holes. Six connections, which form the fluid intakes and outlets for the two flow paths, are all located at the same end of the stack of plates in the heat exchanger. Another connector is connected to the first section to form a fluid intake for the reservoir, and a further connector is connected to the second section to form a fluid outlet for the reservoir.

### CROSS-REFERENCE TO RELATED APPLICATIONS

This application claims priority from German Patent Application No. DE 102024111894.6, filed on Apr. 29, 2024, the entirety of which is hereby incorporated by reference herein.

The invention relates to a heat exchanger made of plates with two flow paths and a reservoir, in particular for a thermal management module.

DE 10 2012 217 090 A1 discloses a heat exchanger (condenser) with which a refrigerant can be condensed, in order to store and super-cool it. This heat exchanger (condenser) contains plates (which are stacked), a first flow channel for a refrigerant, and a second flow channel for a coolant. There are numerous plates (panels), which are stacked to form channels between them, a first part of the channels belonging to the first flow path (flow channel), while a second part of the channels belongs to the second flow path (flow channel). The first flow path contains a first section for cooling and condensing the vaporous refrigerant, and a second section for super-cooling the condensed refrigerant, with a reservoir for storing a refrigerant, which flows from the first section into the second section through the reservoir. According to the invention, the reservoir is connected to the first section by a first connector forming the fluid intake for the reservoir, and a second connector is connected to the second section by a fluid outlet for the reservoir. The first and second connectors can be tubes that pass through holes in the plates. Fluid flows through the second flow path, which has a fluid intake and outlet at the same end of the stack of plates. The reservoir is connected to the heat exchanger. The reservoir is brazed to one end of the stack of plates. The reservoir contains a cylinder. The connectors for the fluid intakes and outlets in the two flow paths, for the refrigerant and coolant, are at different ends of the stack of plates. The body of the motor vehicle defines the amount of available installation space for all of the systems and components. Because the number of systems and components in a motor vehicle is constantly increasing, the available installation space for the heat exchanger with a reservoir is constantly decreasing. This may mean that the disclosed heat exchanger will not fit with its reservoir in the available installation space. This is because the disclosed heat exchanger is unfortunately brazed to the reservoir. This heat exchanger, with a reservoir, is often combined with other components, such as an expansion valve or compressor, to obtain a thermal management module. The available installation space for the heat exchanger with a reservoir thus becomes even smaller. If there is not enough installation space for the heat exchanger and its reservoir in a thermal management module, they must be separated. This requires more lines for the refrigerant and coolant. This also increases the weight and the space needed for the heat exchanger, the reservoir, and the connecting lines. This also complicates the layout for the connecting lines.

The device obtained with the invention, which has the features of the independent claims, has the advantage that the heat exchanger and reservoir are separated, thus reducing the necessary installation space for the heat exchanger and its reservoir, such that it is easier to integrate the heat exchanger and reservoir in a thermal management module.

The basis of the invention is a heat exchanger with a reservoir, preferably for a thermal management module, which contains plates in a stack or placed next to one another. This heat exchanger, or thermal management module, can be used in a refrigerant circuit and/or coolant circuit in a motor vehicle. The motor vehicle can be powered by an at least partially electric drive. The thermal management module contains at least one heat exchanger with a reservoir obtained with the invention, at least one expansion valve, and at least one compressor. The thermal management module can contain sensors, pumps, other valves, a control unit, and other heat exchangers, thus forming most of the components needed for a coolant circuit and/or refrigerant circuit. The heat exchanger obtained with the invention, in particular for a thermal management module in a motor vehicle, contains numerous plates, a first flow path for a coolant, a second flow path for a refrigerant, and a reservoir for separating gaseous and liquid portions of the refrigerant and/or for collecting and storing the refrigerant. The two flow paths are separated from one another and allow for heat exchange between them. A medium containing glycol can be used for the coolant, and R1234yf, carbon dioxide (R744), or propane (R290) can be used for the refrigerant. The numerous plates in the heat exchanger obtained with the invention form identical rectangles. The plates can be rectangular or square. Only the end plates and those inside the stack that have an additional function, such as diverting or blocking a fluid in the flow path, have a different structure. The plates can contain a metal such as an aluminum alloy. The plates can have a raised outer edge. These plates are stacked or placed next to one another such that channels are formed between them. Hollow chambers are formed between adjacent plates, which are subdivided by the channels. The hollow chambers can be sealed off from the environment by the outer edge. The plates can be structured. These structures increase the surface area of the plates that is available for heat exchange. They also subdivide the hollow chambers between the plates into channels. The fluids flowing through the channels may exhibit turbulence generated by the structures, which improves the heat exchange between the two fluids. The structures and edges of the plates may have connecting points where they are joined to one another to obtain the stacked structure. The plates are connected to one another at these points, e.g. by brazing. A first part of the channels belongs to the first flow path. A second part of the channels belongs to the second flow path. The second flow path contains a first section for cooling and condensing the vaporous refrigerant. A least part of the heat is then transferred from the refrigerant to the coolant. The second flow path contains a second section for super-cooling the condensed refrigerant. The refrigerant flows from the first section to the second through the reservoir. The heat exchanger obtained with the invention contains six connectors, which form the fluid intakes and outlets for the two flow channels. The reservoir contains two connectors. Another connector is connected to the first section to form a fluid intake for the reservoir. Another connector is connected to the second section to form a fluid outlet for the reservoir. The plates used for the invention have at least five holes. Some of these holes are surrounded by an edge, an eyelet, or rim, and some are not. This allows for the hollow chambers and channels between two adjacent plates, which have two sections and two flow paths, to be separated from or connected to one another. When adjacent plates have holes surrounded by an edge, eyelet, or rim, the fluid flows into the second hollow chamber, or a channel can be formed that conducts the fluid through this section of the heat exchanger obtained with the invention. A separation is understood to mean that no fluid, or only an insignificant amount, can pass through the connection. The stack of plates is understood to be plates stacked on top of one another, or adjacent to one another, when the heat exchanger obtained with the invention has been assembled.

By way of example, a refrigerant circuit in an air conditioner or heater for a motor vehicle can contain the following components: a heat exchanger with a reservoir obtained with the invention, forming an indirect condenser for a refrigerant, an expansion valve in which the refrigerant can decompress, a vaporizer for the refrigerant, a compressor for the refrigerant, and connecting lines. Refrigerant flows through the refrigerant circuit. Conceivably, R1234yf flows through the refrigerant circuit. Other refrigerants include carbon dioxide (R744), propane (R290), and R134a. The heat exchanger with a reservoir obtained with the invention, the expansion valve, and the compressor can be combined to obtain a thermal management module. Heat can be drawn from the interior of a motor vehicle by the vaporizer, which can then be transferred to a coolant by the heat exchanger by condensing and cooling a refrigerant in the heat exchanger. The reservoir increases the efficiency of the refrigerant circuit in different environmental conditions by storing refrigerant in the reservoir, which is then released as needed. The reservoir is structured such that the different phases of the refrigerant are separated by gravitational forces. The various environmental conditions can relate to the different seasons of the year. Because the refrigerant circuit is closed and contains only one reservoir, this circuit can be self-regulating. The refrigerant circuit can contain a high-pressure section in which the heat exchanger forms an indirect condenser, and a low-pressure section formed by the vaporizer. The refrigerant is at a significantly higher presser in the high-pressure section than in the low-pressure section. The reservoir can be placed in the high-pressure section such that refrigerant flows through it that has already passed through a first section of the heat exchanger. The vaporous refrigerant may not have become entirely liquid by the cooling at pressure in the first section of the heat exchanger, such that it still contains vaporous portions. By placing the reservoir after the first section of the heat exchanger, it can be ensured that only liquid refrigerant can exit the reservoir. The refrigerant exiting the reservoir is cooled further in the second part of the heat exchanger. By super-cooling it, it is possible to prevent bubbles from entering the expansion valve, which would otherwise damage it, thus ensuring that the refrigerant circuit continues to function reliably. The extent to which the refrigerant must be cooled depends on the design, pressure losses in the refrigerant circuit, and the difference in the heights of the condenser and the vaporizer. The efficiency of the refrigerant can be further increased by further cooling the refrigerant.

The coolant is sent to and recovered from the hollow chambers and channels through two of the at least five holes in the plates. The refrigerant is conducted through the heat exchanger by the other holes in the plates. By dividing the second flow path into a first and second section, in which the gaseous refrigerant is condensed and then super-cooled respectively, it is ensured that fully super-cooled refrigerant always exits the heat exchanger. The heat exchanger obtained with the invention must have at least six connectors: two connectors forming intakes and outlets for the coolant, two connectors forming the fluid intakes and outlets for the refrigerant, and two connectors that connect the reservoir to the second flow path for the refrigerant. The second section, for super-cooling the refrigerant, is above the first section, for condensing the refrigerant, in the stack of plates. For this reason, the refrigerant that flows through the first section and subsequently the reservoir, then flows through the second section. This is why the plates must have at least five holes. This is illustrated with two of the at least five holes. The coolant, or refrigerant, is then supplied to and recovered from the hollow chambers and channels in the second section through the other four of the at least five holes. To simplify production, a plate with at least five holes is used. Holes that are not used in a plate within the stack can be blocked in the two flow paths, or the flow paths formed by these holes are not used in the stack. By spatially separating the heat exchanger and the reservoir, and by placing five of the six connectors at the same end of the stack, the necessary installation space for the heat exchanger with a reservoir can be further reduced, and the number of connecting lines that is required for the connectors can also be reduced.

According to the invention, the reservoir and heat exchanger are separated from one another, and/or spaced apart from one another. This advantageously reduces the structural height of the heat exchanger with a reservoir obtained with the invention. The structural height is substantially determined by the height of the stack of plates and/or the diameter of the reservoir.

In a first embodiment of the heat exchanger with a reservoir, the heat exchanger and reservoir can be separated from one another. By way of example, the heat exchanger and reservoir can each be attached to a mounting plate or distributor plate. The distributor plate can contain the channels necessary for the fluids.

In a second embodiment of the heat exchanger with a reservoir, the heat exchanger and reservoir can be spaced apart. By way of example, the heat exchanger and reservoir can each be attached to a distributor plate. The distributor plate can contain the channels necessary for the fluids.

In another embodiment of the heat exchanger obtained with the invention, the plates can each contain at least six holes. The six connectors can all be on the same end of the stack of plates in the heat exchanger. The heat exchanger can contain a distributor plate. The connectors for the fluid intakes and outlets are on one end of the stack of plates. This advantageously results in a heat exchanger that has two sections, which has all of the connectors for the fluid intakes and outlets for a refrigerant and coolant at one end of the stack of plates. The end of the stack of plates can comprise at least one plate and one cover plate. By spatially separating the heat exchanger from the reservoir, and placing six connectors at the same end of the stack of plates, the necessary installation space for the heat exchanger with a reservoir can be further reduced, and the number of lines needed for connecting to the connectors can also be further reduced.

In another particularly beneficial embodiment of the invention, the heat exchanger can contain at least one distributor plate. This distributor plate can contain the channels necessary for supplying the coolant to the heat exchanger, and then recovering the coolant therefrom, or supplying it to the reservoir and recovering it therefrom. The at least one distributor plate can contain six channels, which can lead to the six connectors.

A preferred exemplary embodiment is characterized in that the refrigerant is diverted at least once along the height of the heat exchanger in a first section. This results in a U-shaped path for the refrigerant. This advantageously improves the performance of the heat exchanger, and a greater amount of refrigerant can be cooled and condensed in the first section. The refrigerant can be diverted numerous times along the height in the first section, thus further improving the performance of the heat exchanger obtained with the invention.

In another preferred exemplary embodiment, the plates can each be rectangular, with sides of two different lengths, wherein four holes are placed along one of the sides. The reservoir can be connected thereto, such that the refrigerant can be cooled and condensed in the first section and diverted at least once along the height, after which the refrigerant is super-cooled in the second section.

The plates also preferably have six holes. This allows sections to be formed in the heat exchanger with a reservoir obtained with the invention in which the refrigerant flows in the first channel in the same direction or counter to that of the coolant in the second channel. This advantageously further improves the performance of the heat exchanger obtained with the invention. The plates can each have a longer side and a shorter side. Four of the six holes can be placed along one of the shorter sides, and the two other holes can be placed on the opposite side.

It is particularly preferred that the plates are rectangular, with sides of two different lengths, in which at least three of the holes are placed along one side. The plates can each have at least five holes, and one pair of long sides and one pair of short sides. Three of the at least five holes can be on one shorter side, and the other two holes can be on the opposite shorter side. Consequently, five of the six connectors can be placed at the same end of the heat exchanger obtained with the invention.

It is also preferred that the plates are each rectangular, with sides of two different lengths, wherein the plates each have six holes, and three of the holes are placed opposite one another on these sides. Consequently, the six connectors can be placed at the same end of the heat exchanger obtained with the invention. Placing the holes in two rows of three results in plates with a symmetrical structure. This simplifies production, because it is not necessary to ensure that the plates are all oriented in the same direction when stacking them.

It is also preferred that the plates have an even number of holes, which are arranged symmetrically. An even number is understood to be a number of holes that can be divided evenly by two. Symmetry refers to a geometrical object that can be mapped onto itself through reflection, such that its appearance remains unchanged. The plates can each have a shorter side and a longer side. The plates can each have six holes. The six holes can be in two rows of three along opposite shorter sides. The plates could also have eight holes. These eight holes could be in two rows of four on opposite shorter sides. As a result of the even number of holes and the symmetrical arrangement thereof, the plates advantageously have a symmetrical structure. This simplifies production, because the orientation of the plates is unimportant when stacking them. Because the plates each have six or eight holes, sections can be formed in the heat exchanger obtained with the invention in which the refrigerant flows in the first channel in the direction opposite to, or in the same direction as, the coolant in the second channel. This advantageously further improves the performance of the heat exchanger obtained with the invention.

The plates in the heat exchanger obtained with the invention can each have structures that increase the surface area available for exchanging heat between the refrigerant and the coolant. This further improves the performance of the heat exchanger. The structures can form grooves running in a zig-zag. This generates turbulence in the refrigerant and coolant flows. Consequently, the heat exchange between the refrigerant and coolant is further increased, further improving the performance of the heat exchanger obtained with the invention.

It may also be advantageous when fluid flows through the second path serially or in parallel. Refrigerant flows through the second flow path. It is even more advantageous when the coolant flows through the first path serially or in parallel. This further improves heat exchange between the refrigerant and coolant.

In a particularly beneficial version of the invention, the heat exchanger can have at least one separating plate or plane. The at least one separating plate can have one less hole than the other plates. By way of example, if the other plates have six holes, the at least one separating plane has five. It is possible to first form the plates, and then cut the holes. The separating plate can then be made with one less hole. The separating plate can then divert a fluid in the vertical direction, or separate the first section from the second. Instead of a separating plate, a separating plane can be formed in one of the holes. The separating plate or plane can block or divert channels in the flow paths. The main advantage of creating a heat exchanger with stacked or adjacent plates is that the plates are geometrically substantially identical, and only the cover plates and separating plates are geometrically different. This results in a simple and inexpensive production.

The reservoir also preferably contains at least two cylinders. Ideally, these at least two cylinders are substantially parallel to one another. The cylinders can form tubes that are closed off at each end by caps. The gaseous and liquid portions of the refrigerant can be separated and/or collected and stored in the reservoir. By distributing the volumes of gaseous and liquid portions of the refrigerant that are to be separated from one another and/or collecting and storing the refrigerant in two cylinders, the structural height of the reservoir can be advantageously reduced, thus further reducing the necessary installation space for the heat exchanger with a reservoir obtained with the invention. The reservoir can be made of a metal such as aluminum. The two cylinders can be obtained in an extrusion process, and the caps can be bonded thereto. These two cylinders are connected to one another for fluid exchange. The reservoir has two connectors for the fluid intake and outlet, with which the reservoir is connected to the heat exchanger. The reservoir is used to increase the efficiency of the refrigerant circuit in different environmental conditions by storing refrigerant in the reservoir, and releasing it as needed. The different environmental conditions can be the different seasons of the year. The term “substantially” indicates an angular deviation of ±10° and/or a length deviation of ±1 mm.

In a particularly beneficial version of the invention, the reservoir can contain a single cylinder. The cylinder can be formed by a tube closed at each end with caps. The gaseous and liquid portions of the refrigerant can separated from one another, and/or the refrigerant can be collected and stored in the reservoir. The reservoir can be made of a metal such as aluminum. The cylinder can be produced in an extrusion process, and the caps can be bonded thereto. The reservoir has two connectors for the fluid intake and outlet, with which it is connected to the heat exchanger. The reservoir is used to advantageously increase the efficiency of the refrigerant circuit in different environmental conditions, in that refrigerant is stored in the reservoir and released as needed. The different environmental conditions can be the different seasons of the year.

It may also be advantageous to place at least one filter and/or desiccant inside the reservoir. The filter protects other components such as the heat exchanger against damage and contaminants. The desiccant can be in small bag. The desiccant is used to draw moisture from the fluid. This protects the components in the refrigerant circuit against corrosion, thus preventing potential disruptions caused by water. The at least one filter and/or desiccant can be placed in the cylinder inside the reservoir.

According to the invention, the thermal management module for a motor vehicle contains at least one compressor or at least one pump, at least one expansion valve, and at least one heat exchanger with a reservoir obtained with the invention. The heat exchanger with a reservoir is one of the exemplary embodiments thereof described above, and the heat exchanger and the reservoir are spatially separated from one another. The heat exchanger can be an indirect condenser. The thermal management module can be used in a motor vehicle that has an at least partially electric drive. The body of the motor vehicle defines the available installation space for all of the systems and components of a motor vehicle. The various thermal circuits of the motor vehicle with an at least partially electric drive can be combined in the thermal management module obtained with the invention. These can be the coolant circuit for the batteries, the coolant circuit for the electric drive, the refrigerant circuit for the interior air conditioner, and the refrigerant circuit for a heat pump. By combining the thermal circuits in the thermal management module obtained with the invention, the efficiency of the motor vehicle with an at least partially electric drive can be increased by reducing the amount of energy that would otherwise be taken from the battery that is necessary for heating and cooling. This can be obtained by combining a coolant circuit for the batteries and a refrigerant circuit for a heat pump. The number of lines needed for the refrigerant and/or coolant can also be reduced by integrating components in the thermal management module obtained with the invention. This reduces the installation space needed for the thermal management module, as well as the weight thereof. By eliminating lines, the amount of coolant and/or refrigerant can also be reduced. The heat exchanger and reservoir obtained with the invention are separated from one another, thus further reducing the necessary installation space for the thermal management module. By combining the components in a thermal management module obtained with the invention, the installation thereof can also be simplified. The thermal management module can also contain other components, e.g. bi-directional and tri-directional valves, an additional heat exchanger (e.g. a chiller), and a control unit. The thermal management module obtained with the invention can be used in a refrigerant circuit and/or a coolant circuit.

In a first exemplary embodiment, the thermal management module can contain a compressor, an expansion valve, and a heat exchanger with a reservoir obtained with the invention.

In a second exemplary embodiment, the thermal management module obtained with the invention can contain a compressor, an expansion valve, a heat exchanger with a reservoir obtained with the invention, a pump, and an additional heat exchanger.

According to the invention, the refrigerant circuit and/or coolant circuit contain at least one thermal management module obtained with the invention. In a first use of the invention, the thermal management module can be used in a coolant circuit for a motor vehicle. The motor vehicle can have an at least partially electric drive. The coolant circuit obtained with the invention can contain at least one heat source and an electric motor, and a coolant such as oil can flow through it. To obtain the highest possible level of performance from the electric motor, and reduce power losses, the heat generated when the electric motor is operating must be discharged as quickly as possible. Premature aging of the oil can be prevented if heat is discharged as constantly as possible. The thermal management module can contain a pump, an expansion valve, and a heat exchanger with a reservoir obtained with the invention. The oil can flow through the first path, and another fluid can flow through the second path in the heat exchanger obtained with the invention. The second fluid can be carbon dioxide (R744) or propane (R255), for example. This allows the heat from the oil to be transferred to the second fluid. The pump can convey the oil through the coolant circuit. The pump generates pressure that conveys the coolant from the heat source to the heat exchanger obtained with the invention, and back. The expansion valve regulates the pressure and the temperature of the oil that circulates through the coolant circuit obtained with the invention. By integrating the pump, expansion valve, and heat exchanger with a reservoir obtained with the invention in the thermal management module, some of the lines for the coolant in the coolant circuit can be eliminated. By spatially separating the heat exchanger and reservoir, the thermal management module obtained with the invention can be adapted to the available installation space in the motor vehicle.

The thermal management module can also be used in a refrigerant circuit in a motor vehicle. The motor vehicle can contain an at least partially electric drive. The refrigerant circuit obtained with the invention can be part of a heat pump system. In a motor vehicle with an at least partially electric drive, the electricity needed to heat the interior is obtained from batteries. This reduces the travel range of the motor vehicle. With a heat pump system, the heat needed to heat the interior can be obtained from the environment, thus increasing the travel range of the motor vehicle with an at least partially electric drive. A heat pump system can be composed of at least three parts: a heat source, which obtains heat from the environment, at least one heat pump that contains the refrigerant circuit obtained with the invention, and at least one heater for the interior or the batteries. The heat source can be air. A refrigerant such as carbon dioxide (R744) or propane (R245) can flow through the refrigerant circuit. Heat can be obtained from air using a heat exchanger in the form of a direct vaporizer with which the refrigerant is vaporized. The thermal management module can contain a compressor, an expansion valve, and a heat exchanger with a reservoir obtained with the invention. The refrigerant can be condensed in the heat exchanger, and the heat can be transferred to another fluid. The heat exchanger obtained with the invention can thus be operated as an indirect condenser. The refrigerant can be pressurized in the compressor, thus increasing the pressure of the refrigerant, and the pressure of the refrigerant can be reduced again in the expansion valve. The gaseous refrigerant can be superheated in the second section of the first flow path in the heat exchanger obtained with the invention, such that any remaining liquid is vaporized. An ingress of liquid portions of the refrigerant in the compressor can thus be prevented, further improving the performance of the refrigerant circuit obtained with the invention. This is because more power can be transferred. The liquid refrigerant can be further cooled, thus liquifying any remaining gaseous portions. An ingress of gaseous portions in the expansion valve can thus be prevented. By integrating the compressor, expansion valve, and heat exchanger with a reservoir obtained with the invention, some of the lines in the refrigerant circuit obtained with the invention can be eliminated. By spatially separating the heat exchanger and the reservoir, the thermal management module obtained with the invention can be adapted to the available installation space in the motor vehicle.

The thermal management module obtained with the invention can also be used in a coolant circuit and a refrigerant circuit in a motor vehicle with an at least partially electric drive. The coolant circuit obtained with the invention can contain at least one heat source, such as a battery, and a coolant can flow through it. The pump, expansion valve, and heat exchanger obtained with the invention are integrated in the thermal management module obtained with the invention. In motor vehicles with an at least partially electric drive, the batteries and electric motors should be kept at a constant temperature to obtain the longest possible service life and highest performance. In hot environments, the cooler (indirect condenser) in the coolant circuit may not be powerful enough. In this case, an additional heat exchanger can be integrated in the thermal management module obtained with the invention. The first flow path in the heat exchanger obtained with the invention can be incorporated in the coolant circuit, and the second flow path can be incorporated in the refrigerant circuit. Because the refrigerant is colder, the coolant can cooled to the point that the batteries and drive motor can be kept at a constant temperature. The additional heat exchanger is thus used as a chiller. By integrating the pump, expansion valve, heat exchanger obtained with the invention, and the additional heat exchanger with a reservoir in the thermal management module obtained with the invention, some of the lines in the coolant circuit and in the refrigerant circuit can be eliminated. By spatially separating the heat exchanger and the reservoir, the thermal management module obtained with the invention can be adapted to the available installation space in the motor vehicle. A coolant that is a mixture of water and glycol can flow through the coolant circuit obtained with the invention. A refrigerant can flow through the refrigerant circuit obtained with the invention. The refrigerant can be carbon dioxide (R744) or propane (R245).

In the drawings:

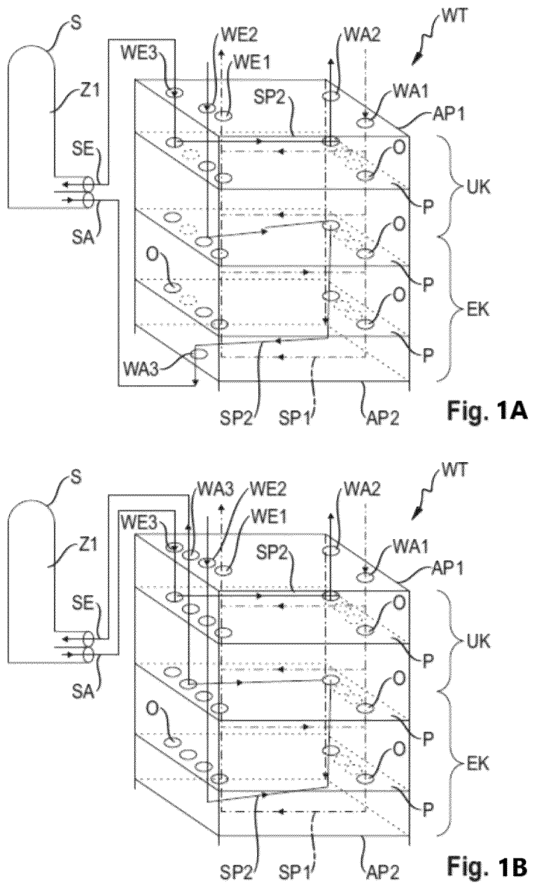

FIG. 1A shows a schematic illustration of a first embodiment of the heat exchanger obtained with the invention, with a reservoir in which refrigerant can be condensed in order to store and super-cool it, wherein the reservoir and heat exchanger are separated from one another;

FIG. 1B shows a schematic illustration of a second embodiment of the heat exchanger obtained with the invention, with a reservoir in which refrigerant can be condensed in order to store and super-cool it, wherein the reservoir and heat exchanger are separated from one another;

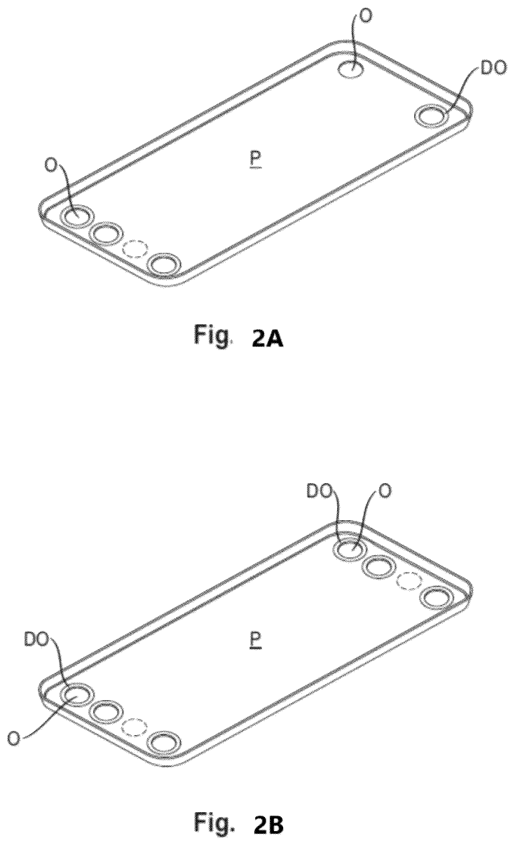

FIG. 2A shows a top perspective view of a first embodiment of a plate usable with the embodiment of FIG. 1A or 1B embodiments of the plates from above;

FIG. 2B shows a top perspective view of a second embodiment of a plate usable with the embodiment of FIG. 1A or 1B embodiments of the plates from above; and

FIG. 3 shows a first embodiment of the thermal management module obtained with the invention from above.

FIG. 1 shows schematic illustrations of two embodiments of the heat exchanger WT with a reservoir S obtained with the invention. The heat exchanger WT with a reservoir S obtained with the invention can be used in a thermal management module (not shown) for a refrigerant circuit and/or coolant circuit in a motor vehicle. The heat exchanger WT is composed of numerous stacked plates P. Most of the plates P are geometrically identical, with only the cover plates AD1, AD2 one either end of the stack and separating plates (not shown) differing geometrically from the other plates P. The plates P, cover plates AD1, AD2 and separating plates in the heat exchanger WT obtained with the invention contain a metal such as an aluminum alloy, and are brazed to one another. This results in a simple and inexpensive production.

The heat exchanger WT with a reservoir S obtained with the invention is only schematically illustrated in FIG. 1. The individual sections of the heat exchanger WT, such as the first section EK and second section UK, are only indicated by block-shaped elements in FIG. 1. Each of these block-shaped elements is actually composed of numerous plates P. The plates P each have at least five holes O. Additional optional holes O in the plates P are indicated by broken lines. The plates P are rectangular, with longer and shorter sides. Three of the at least five holes O are on one of the shorter sides of the plates P, and the at least two other holes O are on the opposite side. The plates P have a raised edge (not shown). Some of the holes O can be surrounded by eyelets (not shown). The placement of holes with eyelets (not shown) forms hollow chambers (not shown) that are separated from one another between adjacent plates P. These plates P can have structures (not shown). Channels (not shown) are formed between the plates P. A first part of these channels belong to the first flow path SP1, and a second part of these channels belong to the second flow path SP2. These first and second parts of the channels can alternate in the stack of plates. A coolant flows through the first flow path SP1, which is schematically indicated by a broken line. The coolant can be a mixture of water and glycol. A refrigerant flows through the second flow path SP2, which is schematically indicated by a solid line. The refrigerant can be R1234yf or carbon dioxide (R744). This illustration is intended to show how the fluids flow through the heat exchanger WT with a reservoir S obtained with the invention. The second flow path SP2 in the heat exchanger WT is formed by a first section EK and second section UK. The first section EK is used to heat the refrigerant from the vaporized phase to a liquid phase. By transferring heat from the refrigerant to the coolant, the refrigerant is cooled and condensed. The coolant flows through the first section WK in the first flow path SP1. The refrigerant is diverted once over the height of the heat exchanger WK in the first section EK. The second section UK is above the first section WK. The liquid refrigerant is cooled further in the second section UK by transferring more heat to the coolant. The coolant flows through the second section in the first flow path SP1. The reservoir S is separated from and next to the heat exchanger WT. The refrigerant flows through the first section EK first, and then the second section UK. The reservoir S is also schematically illustrated, and contains a cylinder Z1. The refrigerant S flows through the reservoir S. A filter for the refrigerant, and/or a desiccant that removes moisture from the refrigerant can placed in the reservoir S. The reservoir is used to separate gaseous portions of the refrigerant from liquid portions, and/or to collect and store the refrigerant. The heat exchanger obtained with the invention has six connectors. Three of these connectors are fluid intakes WE1, WE2, WE3, and the other connectors form fluid outlets WA1, WA2, WA3. The connectors are in the cover plates AD1, AD2. The coolant is supplied through the first fluid intake WE1 and removed through the first fluid outlet WA1, and flows serially through the first section WK and second section UK. The refrigerant is supplied to the first section EK through the second fluid intake WE2 and removed through the second fluid outlet WA2, and conveyed to the reservoir S through the fluid intake SE in the reservoir S. By way of example, the refrigerant can be conveyed through the second section UK and first section EK through holes with eyelets. The refrigerant is removed from the reservoir S through the fluid outlet SA in the reservoir S, and supplied to the second section UK of the heat exchanger WK through the fluid intake WA3. The refrigerant is then removed from the second section UK through the third fluid intake WA3.

A first embodiment of the heat exchanger obtained with the invention is shown from above in FIG. 1A. The plates each have five holes O. Five of the six connectors are on the upper end of the stack of plates in the heat exchanger WT. The sixth connector is at the lower (opposite) end of the stack of plates. The five connectors forming the three fluid intakes WE1, WE2, WE3 and two fluid outlets WA1, WA2 are at the upper end of the stack of plates. The sixth connector, which forms the third fluid outlet WA3, is at the lower end of the stack of plates. By separating the heat exchanger WK and reservoir S, an advantageously compact structure is obtained with a low structural height.

A second embodiment of the heat exchanger obtained with the invention is shown from above in FIG. 1B. The plates P each have six holes O. Three of the holes O are on the shorter sides. The six connectors are at the upper end of the stack of plates in the heat exchanger WT. The six connectors, which form the three fluid intakes WE1, WE2, WE3 and three fluid outlets WA1, WA2, WA3 are at the same end of the stack of plates. The six connectors are at the upper end of the stack of plates. By separating the heat exchanger WK and reservoir S, and placing all six connectors at the same end of the stack of plates, a more compact structure is obtained, which has an even lower structural height.

FIG. 2 shows first and second embodiments of plates P obtained with the invention. The plates P are rectangular, with short sides and long sides. The edge surrounding each plate P is raised. The plates P can have structures (not shown), which increase the surface area available for heat exchange. These structures can form the first part of the channels between the plates for the first flow path (not shown), and the second part of the channels between the plates for the second flow path (not shown). The plates P each have at least five holes O, and they can also have additional, optional holes O. The optional holes O are indicated by broken lines. Some of the holes O can be surrounded by an eyelet DO. Three of the holes O are placed along the shorter side.

A first embodiment of a plate P obtained with the invention is shown from above in FIG. 2A. The plate P has five holes O and an optional hole O. Four of the holes O are placed along one of the shorter sides and one of the three inner holes O is the optional hole O. There are two holes O on the side opposite these four holes O.

A second embodiment of a plate P obtained with the invention is shown from above in FIG. 2B. This plate P has six holes O and two optional holes. There are four holes along each of the shorter sides. One of the inner holes is the optional hole O. This results in a plate with a symmetrical arrangement of the holes O. thus simplifying production of the heat exchanger. At least two of the holes are surrounded by an eyelet DO.

FIG. 3 shows a first embodiment of the thermal management module 100 obtained with the invention. The thermal management module 100 contains, e.g. a first embodiment of the heat exchanger WT with a reservoir S obtained with the invention, a compressor KP, and an expansion valve EP. The reservoir S is separated and spaced apart from the heat exchanger WT. The compressor KP, expansion valve EV, heat exchanger WT, and reservoir S are connected to a distributor plate VP. The distributor plate VP contains the channels (not shown) needed to connect the components for fluid exchange. The thermal management module 100 shown in FIG. 3 can be part of a refrigerant circuit and/or coolant circuit for a motor vehicle. A refrigerant can be condensed in the heat exchanger WT, and the heat can be transferred to a coolant. The heat exchanger WT can thus be used as an indirect condenser. A refrigerant can be condensed in the compressor KP. thus increasing the pressure of the refrigerant, and the pressure of the refrigerant can be reduced again in the expansion valve EP. The gaseous and liquid phases of the refrigerant can be separated from one another in the reservoir S, and/or the refrigerant can be stored therein. The reservoir S is substantially formed by a cylinder Z1. By integrating the compressor KP, expansion valve EV and heat exchanger WT with a reservoir S obtained with the invention in the thermal management module 100, some of the lines in the refrigerant circuit and coolant circuit can be eliminated, and by integrating the components in a thermal management module, the necessary installation space can be reduced. Because the reservoir S and heat exchanger WT are separated, the height of the thermal management module 100 can be reduced, and better use can be made of the available installation space in the body of a motor vehicle.

The specification can be readily understood with reference to the following Numbered Paragraphs:

Numbered Paragraph 1. A heat exchanger (WT), in particular for a thermal management module (100) in a motor vehicle, containing:
numerous plates (P),
a first flow path (SP1) for a coolant,
a second flow path (SP2) for a refrigerant,
a reservoir(S) for separating gaseous and liquid portions of the refrigerant from one another and/or for collecting and storing the refrigerant, and
six connectors, which form the fluid intakes (WE1, WE2, WE3) and fluid outlets (WA1, WA2, WA3) for the two flow channels (SP1, SP2),
wherein the plates are stacked or placed next to one another such that channels are formed between adjacent plates (P),
wherein a first part of the channels belongs to the first flow path (SP1),
wherein a second part of the channels belongs to the second flow path (SP2),
wherein the second flow path (SP2) has a first section (EK) for cooling and condensing the vaporous refrigerant,
wherein the second flow path (SP2) has a second section (UK) for super-cooling the condensed refrigerant
wherein another connector is connected to the first section (EK) to form a fluid intake (SE) for the reservoir(S), wherein another connector is connected to the second section (UK) to form a fluid outlet (SA) for the reservoir(S)
wherein the refrigerant flows from the first section (EK) into the second section (UK) via the reservoir(S).
   characterized in that the plates (P) each have at least five holes (O), wherein at least five of the six connectors (WE1, WE2, WE3, WA1, WA2, WA3) are at the same end of the stack of plates in the heat exchanger (WT).

Numbered Paragraph 2. The heat exchanger (WT) according to Numbered Paragraph 1, characterized in that the reservoir(S) and heat exchanger (WT) are separated from one another and/or spaced apart from one another.

Numbered Paragraph 3. The heat exchanger (WT) according to Numbered Paragraph 1 or 2, characterized in that the plates (P) each have at least six holes (O), and the six connectors (WE1, WE2, WE3, WA1, WA2, WA3) are each at the same end of the stack of plates in the heat exchanger (WT).

Numbered Paragraph 4. The heat exchanger (WT) according to Numbered Paragraph 1, 2, or 3, characterized in that the heat exchanger (WT) contains at least one distributor plate (VP).

Numbered Paragraph 5. The heat exchanger (WT) according to Numbered Paragraph 1, 2, 3, or 4, characterized in that the refrigerant is diverted at least once along the height of the heat exchanger (WT) in the first section (EK).

Numbered Paragraph 6. The heat exchanger (WT) according to Numbered Paragraph 1, 2, 3, 4, or 5, characterized in that the plates (P) are each rectangular, with two sides of different lengths, wherein at least three holes (O) are placed along one side.

Numbered Paragraph 7. The heat exchanger (WT) according to any of the preceding Numbered Paragraphs, characterized in that the plates each have an even number of holes (O), wherein the holes (O) are arranged symmetrically.

Numbered Paragraph 8. The heat exchanger (WT) according to any of the preceding Numbered Paragraphs, characterized in that fluid can flow through the second flow path (SP2) serially and/or in parallel.

Numbered Paragraph 9. The heat exchanger (WT) according to any of the preceding Numbered Paragraphs, characterized in that the heat exchanger (WT) contains at least one separating plate (TP) or one separating plane (TE).

Numbered Paragraph 10. The heat exchanger (WT) according to any of the preceding Numbered Paragraphs, characterized in that the flow paths (SP1, SP2) each contain first and last channels, wherein the coolant flow counter to the refrigerant flow in both the first and last channels.

Numbered Paragraph 11. The heat exchanger (WT) according to any of the preceding Numbered Paragraphs, characterized in that heat exchanger (WT) is an indirect condenser.

Numbered Paragraph 12. The heat exchanger (WT) according to any of the preceding Numbered Paragraphs, characterized in that the reservoir(S) contains at least two cylinders (Z1, Z2), wherein the at least two cylinders (Z1, Z2) are substantially parallel to one another, wherein the at least two cylinders (Z1, Z2) are connected to one another for fluid exchange.

Numbered Paragraph 13. The heat exchanger according to any of the Numbered Paragraphs 1 to 11, characterized in that the reservoir(S) contains one cylinder (Z1).

Numbered Paragraph 14. A thermal management module (100) for a motor vehicle, which contains at least one compressor (KP) or at least one pump (PU), at least one expansion valve (EP), at least one heat exchanger (WT) with a reservoir(S) according to at least one of the Numbered Paragraphs 1 to 13.

Numbered Paragraph 15. A refrigerant circuit and/or coolant circuit for a motor vehicle, which contains at least one thermal management module (100) according to Numbered Paragraph 14.

### LIST OF REFERENCE SYMBOLS

WT heat exchanger obtained with the invention

P plates in the heat exchanger obtained with the invention

O holes in the plates

DO eyelet surrounding a hole

VP distribution plate

TP separating plate

TE separating plane

SP1, SP2 flow paths for a coolant and a refrigerant

AP1, AP2 cover plates for the heat exchanger obtained with the invention

EK first section, for cooling and condensing the vaporous refrigerant

UK second section, for super-cooling the condensed refrigerant

WE1, WE2, WE3 fluid intakes for the flow paths in the heat exchanger obtained with the invention

WA1, WA2, WA3 fluid outlets for the flow paths in the heat exchanger obtained with the invention

S reservoir for separating gaseous and liquid portions of the refrigerant and/or collecting and storing the refrigerant

SE fluid intake for the reservoir

SA fluid outlet for the reservoir

100 thermal management module obtained with the invention

KP compressor

PU pump

EV expansion valve

1-15. (canceled)

16. A heat exchanger, in particular for a thermal management module in a motor vehicle, comprising:
a plurality of plates;
a first flow path (SP1) for a coolant;
a second flow path (SP2) for a refrigerant;
a reservoir for separating gaseous and liquid portions of the refrigerant from one another and/or for collecting and storing the refrigerant, and
six connectors, which form the fluid intakes (WE1, WE2, WE3) and fluid outlets (WA1, WA2, WA3) for the first and second flow paths (SP1, SP2),
wherein the plates are stacked or placed next to one another to define channels between adjacent plates,
wherein a first part of each of the channels is within the first flow path (SP1),
wherein a second part of the channels is within the second flow path (SP2),
wherein the second flow path (SP2) comprises a first section for cooling and condensing the gaseous refrigerant,
wherein the second flow path (SP2) has a second section for super-cooling the liquid refrigerant
further comprising another connector that is connected to the first section to define a fluid intake (SE) for the reservoir, and further comprising another connector that is connected to the second section to define a fluid outlet (SA) for the reservoir;
wherein the refrigerant flows from the first section into the second section via the reservoir,
wherein the plates each comprise at least five holes (O), wherein at least five of the six connectors (WE1, WE2, WE3, WA1, WA2, WA3) are at the same end of the stack of plates in the heat exchanger (WT).

17. The heat exchanger according to claim 16, wherein the reservoir and heat exchanger are separated from one another and/or spaced apart from one another.

18. The heat exchanger according to claim 16, wherein the plurality of plates each have at least six holes, and the six connectors (WE1, WE2, WE3, WA1, WA2, WA3) are each disposed at a same end of the stack of plates in the heat exchanger.

19. The heat exchanger according to claim 16, wherein the heat exchanger comprises at least one distributor plate.

20. The heat exchanger according to claim 16, wherein the refrigerant is diverted at least once along a height of the heat exchanger in the first section.

21. The heat exchanger according to claim 16, wherein the plurality of plates are each rectangular, with two sides of different lengths, wherein at least three holes of the five holes upon each plate are located along one side.

22. The heat exchanger according to claim 16, wherein the plates each have an even number of holes, wherein the holes are arranged symmetrically.

23. The heat exchanger according to claim 16, wherein fluid is configured to flow through the second flow path (SP2) serially and/or in parallel.

24. The heat exchanger according to claim 16, wherein the heat exchanger comprises at least one separating plate (TP) or one separating plane (TE).

25. The heat exchanger according to claim 16, wherein the flow paths (SP1, SP2) each comprise first and last channels, wherein the coolant flows counter to the refrigerant flow in both the first and last channels.

26. The heat exchanger according to claim 16, wherein heat exchanger is an indirect condenser.

27. The heat exchanger according to claim 16, wherein the reservoir contains at least two cylinders, wherein the at least two cylinders are substantially parallel to one another, wherein the at least two cylinders are connected to one another for fluid exchange.

28. The heat exchanger according to claim 16, wherein the reservoir contains one cylinder.

29. A thermal management module for a motor vehicle, which comprises at least one compressor or at least one pump, at least one expansion valve, at least one heat exchanger with a reservoir according to claim 16.

30. A refrigerant circuit and/or coolant circuit for a motor vehicle, which comprises at least one thermal management module according to claim 29.
